(19) United States
(12) Patent Application Publication
(10) Pub. No.: US 2001/0043286 A1
(43) Pub. Date: Nov. 22, 2001

(54) Multimedia auto-switch system

(76) Inventors: Gary Kuan-Hong Hsieh, Taipei (TW); Eric Heieh-Hong Chung, Hsin-Tein City (TW)

Correspondence Address: RABIN & CHAMPAGNE, P.C., Suite 500, 1101 14th Street, N.W., Washington, DC, 20005, US

(21) Appl. No.: 09/842,656

(22) Filed: Apr. 27, 2001

(30) Foreign Application Priority Data
May 17, 2000 (TW) 089109635

(51) Int. Cl. H04N 7/00; H04N 11/00; H04N 5/268

(52) U.S. Cl. 348/705; 348/552

(57) ABSTRACT

A system can be used to automatically judge and select latest activated and input signal that has been accepted by the system as the command of executing a certain operation and therefore be displayed on the sound and/or image display device instead of manual switching when multiple signal providing devices are coupled to share a common sound and/or image display device, when the selected executing signal providing device is interrupted, can automatically switch back to output signal from the former or other predefined signal source, and the system can be combined with manual mode so that user can also select one of the multiple signal providing devices as the executing signal manually.

### FIELD OF INVENTION

The present invention relates to a multimedia auto-switch system, especially the one that can automatically judge and select the latest activated and input signal that is accepted by the system as the command of executing a certain operation and as the signal of executing play.

### BACKGROUND OF INVENTION

Multimedia audio/video device on hand is very widespread, e.g., domestic TV set can be coupled to a variety of audio/video signal providing devices such as computer, VCR, video CD player, CD player or CD-ROM via its connective port. Then manual switch can be used firstly to switch signal input path, then to shut down the working audio/video signal-providing device and finally to activate preferred video CD, CDROM or VCR. However, all the present technologies in this field require repeated manual switching, which is inconvenient. As the detailed relative prior arts please refer to U.S. Pat. Nos. 5,923,362 (merging multi-source information in a television system) and 5, 900,916 (control of images from multiple sources on a monitor or television at the same time).

There is complex type remote controller on hand that can be used to select the preferred audio/video signal sources such as video CD player or TV as well as to be coupled to other electrical apparatus, e.g. a multipurpose remote controller can be used to control several domestic electron devices. Generally speaking, each domestic electron device comprises a main body and an infrared remote controller. The main body can detect the infrared signal data eradiated from the remote controller and execute designated functions. The method of remote controlling an electrical apparatus is to receive a comprehensive choice signal comprising function code choice signal, component code choice signal and/or address code choice signal, according to which user can define relative internal code consisting of the above-mentioned function code, component code and address code and transmit to the preferred electrical apparatus. In this way user can achieve the aim of using a single remote controller to control at least one electrical apparatus.

However, this type of remote controller is still not satisfactory, e.g. user needs to predefine the preferred audio/video signal source such as video CD player or TV, and then activate play. Although the frequency of the remote controller's manual switching is much lower than that of the traditional absolutely manual switching, it is still a kind of semi-automatic process. The audio/video signal providing devices are limited to one or several devices that manufacturers have predefined, e.g., video CD player or TV. If user wants to get the display be coupled to other devices such as CD-ROM or VCR, manual switching must be resumed, which would have no difference with the above-mentioned traditional absolutely manual switching.

In addition, the technology of ladder for information processing based on LIFO (last in-first out) mode has been developed for years, as the details please refer to U.S. Pat. Nos. 4,040,018, 4,649,234, 5,535,009, 5,588,113, and 5,804,986.

### SUMMARY OF THE INVENTION

Accordingly, the object of the present invention is to provide a multimedia auto-switch system that enables multiple signal providing devices such as tuner, VCR, video CD player, CD player, CD-ROM and computer to share a common sound and/or image display device and that can automatically judge and select the latest input signal that is accepted by the system as the command of executing a certain operation on the sound and/or image display device and as the signal of executing play.

Another object of the present invention is to provide a multimedia auto-switch system that can automatically judge and select user's preferred signal providing device to execute its command of selecting and play when multiple signal providing devices, in stead of only the limited number of signal sources predefined by manufacturers, are coupled to share a common sound and/or image display device

A further object of the present invention is to provide a multimedia auto-switch system that can be coupled to multiple signal providing devices. When the selected executing signal providing device ceases to play, the auto-switch system can automatically switch back to access the previously selected or predefined signal-providing device and continue to execute play.

This invention also comprises a random memory and access unit. When the selected executing signal providing device is interrupted, this auto-switch system can automatically switch back to access the previously selected or predefined signal-providing device and continue to execute play.

Therefore, unlike traditional complex type tuner that is confined to the limited number of signal sources such as video CD player and TV predefined by manufacturers, this auto-switch system can automatically judge and select user's preferred signal providing device among all that are coupled to share a common sound and/or image display device. This invention makes auto-switch system of multi-source signal be more convenient in that this system can automatically select the latest signal providing device connected or activated by user to output the signal and execute play. At least one reference behavior mode is firstly preset, and then comparing the track from last output signal of the direction and displacement in unit time with the track of the reference behavior mode, if they are similar, then it is determined that the intention of the object is consistent with the mode.

### BRIEF DESCRIPTION OF DRAWINGS

The attached figures illustrate specific embodiments of this multimedia auto-switch system of the present invention, in which:

FIG. 1 is schematic of embodiment of this multimedia auto-switch system.

FIGS. 2 and 3 are flow charts of embodiment of this invention respectively.

FIG. 4 to 7 are schematic of embodiment of operation time sequence of this invention respectively; and

FIG. 8 is circuit schematic of embodiment of output module of this invention.

### DETAILED DESCRIPTION OF THE PREFERRED EMBODIMENT

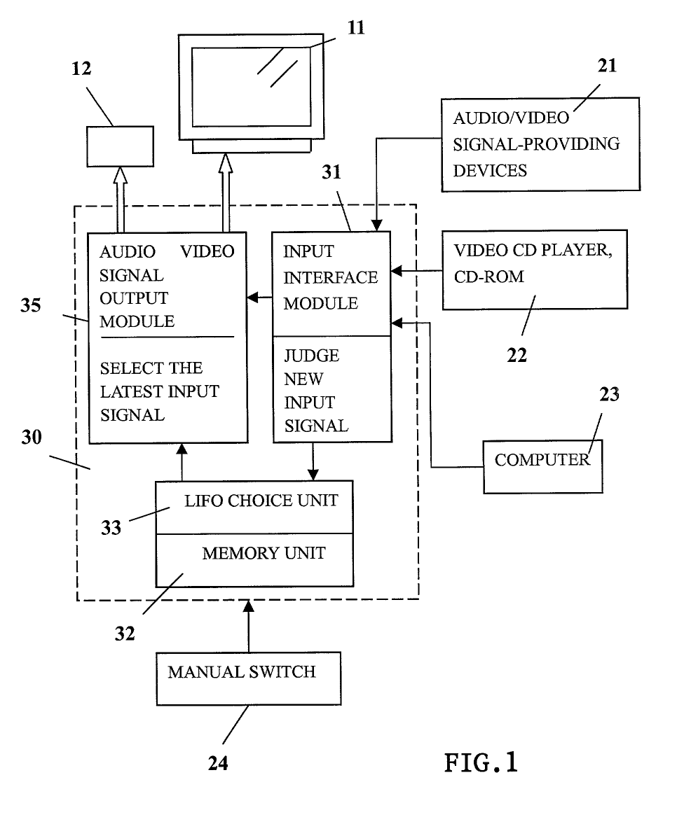

As shown in FIG. 1, this multimedia auto-switch system (30) comprises an input interface module (31) that has multiple input interface module ports to which multiple signal providing devices can be coupled, e.g., computer (23), video CD player, CD-ROM (22) and other audio/video signal providing devices (21). This input interface module can also judge whether there is new input signal. Besides, this auto-switch system also comprises an audio/video signal output module (35) to which at least one sound and/or image display device can be coupled, e.g., speaker that outputs audio signal (12) and/or monitor and screen that output video signal (11). The major component of this auto-switch system is a last-in-first-out (LIFO) choice unit (33) that can automatically judge and select the latest input signal source from said input interface module (31) as the command of executing a certain operation and as the signal of executing play, then transmits to said output module (35) to make sound and/or image display device execute play. A manual switch (24) can provide user convenient to choice a way that to activate the signal input path by manual or automatic.

The implementation of this multimedia auto-switch system of the present invention also comprises a memory unit (32) that can memorize the source of each input audio/video signal and edit the address. This memory unit (32) can automatically access in sequence each signal source that has been selected as the command of executing a certain operation. When the selected executing signal providing device is interrupted, the memory unit can automatically switch back to a certain signal-providing device according to previous setting and continue to execute play of output signal.

There are several embodiments of automatic switching back to predefined signal providing device and continuing to play. FIG. 6 illustrates one embodiment that to access the signal sources from the time system boots in correct sequence as the command of executing a certain operation and transmit to said output module. Another embodiment as shown in FIG. 7, to access the signal sources from the time current executing signal source is interrupted in inverted sequence as the command of executing a certain operation and transmit to said output module.

Based on the above-mentioned technology, this invention can be implemented as a multimedia sound and/or image display device as shown in FIG. 1 that comprises a device for displaying of sound and/or image, an input interface module (31) that has multiple input interface module ports to which multiple above-mentioned signal providing devices can be coupled and a LIFO choice unit (33) that is coupled to said sound and/or image display device at one port and to said input interface module (31) at the other port. This LIFO choice unit can automatically judge and select the latest input signal source from said input interface module as the command of executing a certain operation and transmit the signal to said sound and/or image display device to execute play.

This invention can also be actualized in another implementation based on its technology—a LIFO choice unit and an assembly memory unit that are for the application of this multimedia auto-switch system. As mentioned above and as shown in FIG. 1, the LIFO choice unit and assembly memory unit mainly comprise a LIFO choice unit (32) that is coupled to the sound and/or image displace device at one port and at the other port, to the input interface module (31) that has multiple input interface module ports. This LIFO choice unit can also automatically judge and select the latest input signal source from said input interface module (31) as the command of executing a certain operation and transmit the signal to said sound and/or image display device to execute play.

The above-mentioned LIFO choice unit and the assembly memory unit are made up of built-in microcomputer in the multimedia auto-switch system.

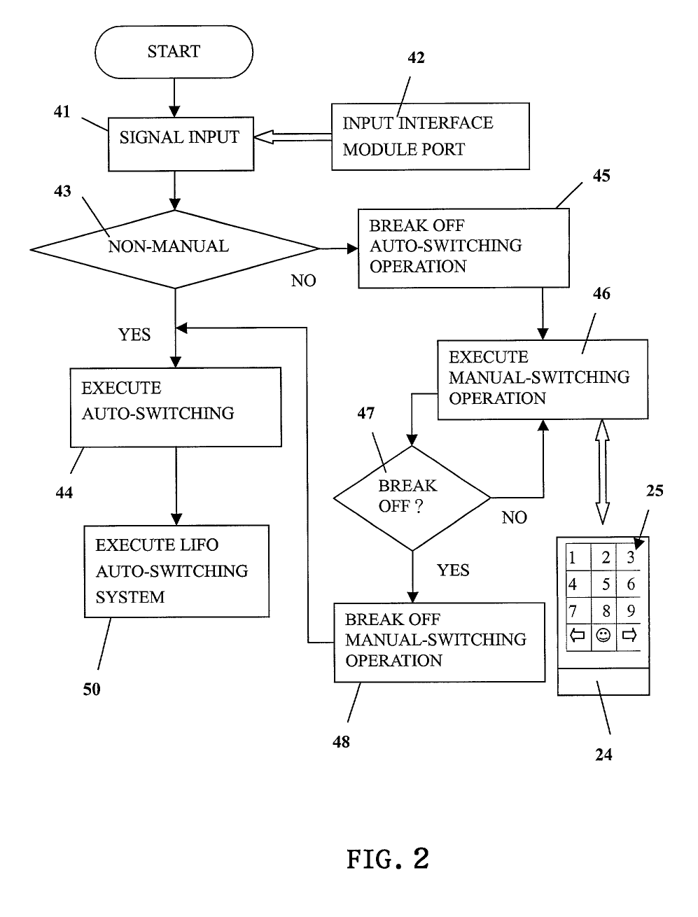

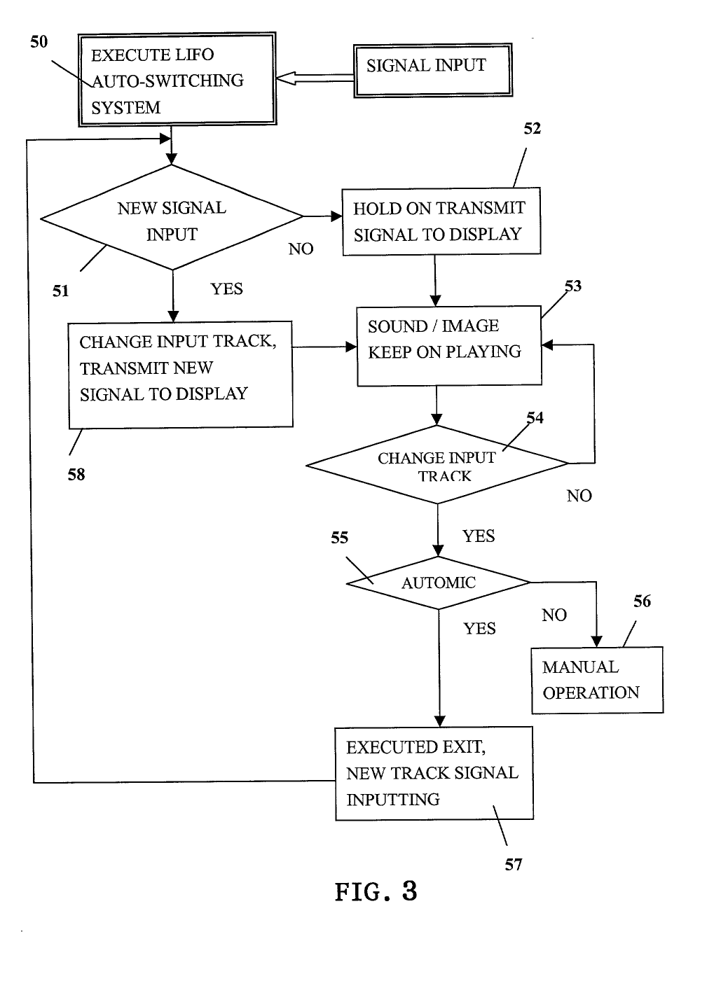

The control flow of the present invention is illustrated in FIGS. 2 and 3. In FIG. 2, after the auto-switch system is activated, the input interface module port (Block 42) will execute signal input (Block 41) from various audio/video signal providing devices (21) continuously as well as automatically detects which mode of operation is at work in manual mode or non-manual (automatic) mode? (Block 43) If not in automatic mode, the system will break off auto-switching (Block 45) and change into manual operation mode (Block 46), in which remote control via manual switch (24), online operation or other kinds of manual operation is involved. In the process of manual operation, user can choose whether to break off or to continue (Block 47). If user chooses to break off manual mode remote control (Block 48), the system will change back into auto-switching. Of course, if the above-mentioned automatically detected input signal is in non-manual (automatic) mode, this system will execute auto-switch (Block 44). In other words, system will execute LIFO auto-switching (Block 50).

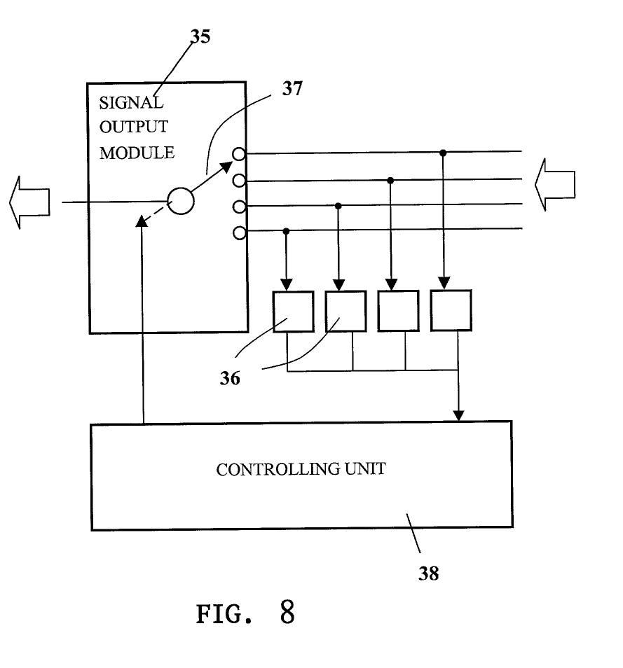

In FIG. 3, if in LIFO switching mode, the system will execute the operation of displaying current sound and/or image signal and continuously detect whether there is new input signal (Block 51)? If no new signal has been detected, the system will continue to transmit current signal to the sound and/or image display device (Block 52) and make it keep on playing (Block 53). However, if any new signal has been detected, the system will execute in LIFO auto-switching mode (detailed explanation please see the following paragraph) and switch to transmit this new signal to display device (Block 58). FIG. 8 illustrates circuit schematic of embodiment of output module (please refer to FIG. 1) of this multimedia auto-switch system. After all the signals are input, they will be judged by a having (no) signal judging unit (36) and conjugate a controlling unit (38) to make the switching unit (37), e.g., relay, digital switch or other proper components, automatically switch to transmit the new signal to display device.

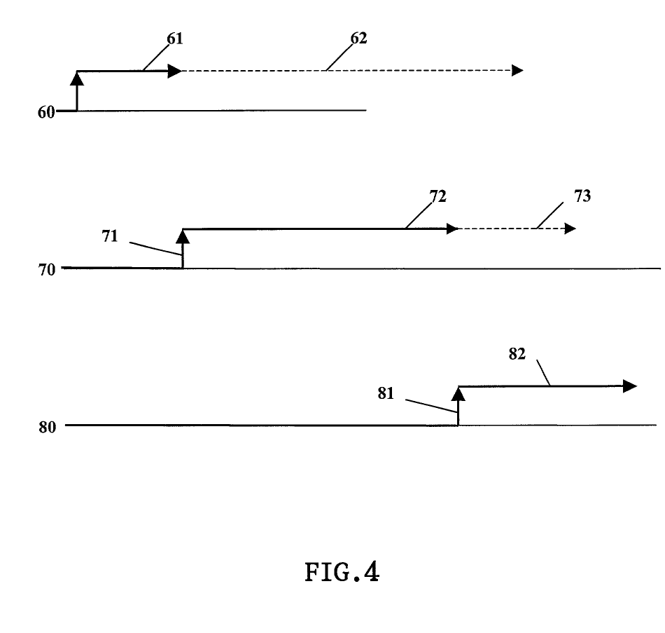

Please refer to FIG. 4, presume that there inputs an audio/video signal (60) as a high signal after the system is activated and becomes a continuous output signal of executing play (61). If there is no other new input signal, this signal will continue to act as the output signal of executing play. However, if a first new audio/video signal (70) is detected to have been input as a high signal (71), it will automatically replace the former audio/video signal (60) to become the new output signal of executing play (72). Meanwhile, the former working signal (61) changes into an ineffective phantom signal (62) immediately. By analogy, if a second new audio/video signal (80) is input as a High signal (81), it will automatically replace the former audio/video signal (70) to become the new output signal of executing play (82). Meanwhile, the former working signal (72) changes into an ineffective phantom signal (73) immediately.

Review FIG. 3, in the process of continuously transmitting new signal to display device (Block 58), if there is a temporary pause, such as shut down within 1 or 0.5 second, or no new signal for change track from signal source (Block 54), the system will continue to output current signal. But if user chooses to switch the signal source, the system will further inspect whether current executing signal level has become low (Block 55). If no, the system will continue to output current signal. If current working device is cut off or ceases to play, the auto-switch system will exit current executing signal and other predefined device will continue to output signal to display device (Block 57). There is also another option in the process to decide which predefined device will be selected to continue the executing of signal output.

The present invention also comprises a memory unit that can automatically access each signal source that has been selected in correct sequence. When the selected executing signal providing device is interrupted, the memory unit can automatically switch back to a certain predefined signal-providing device and continue to execute signal output.

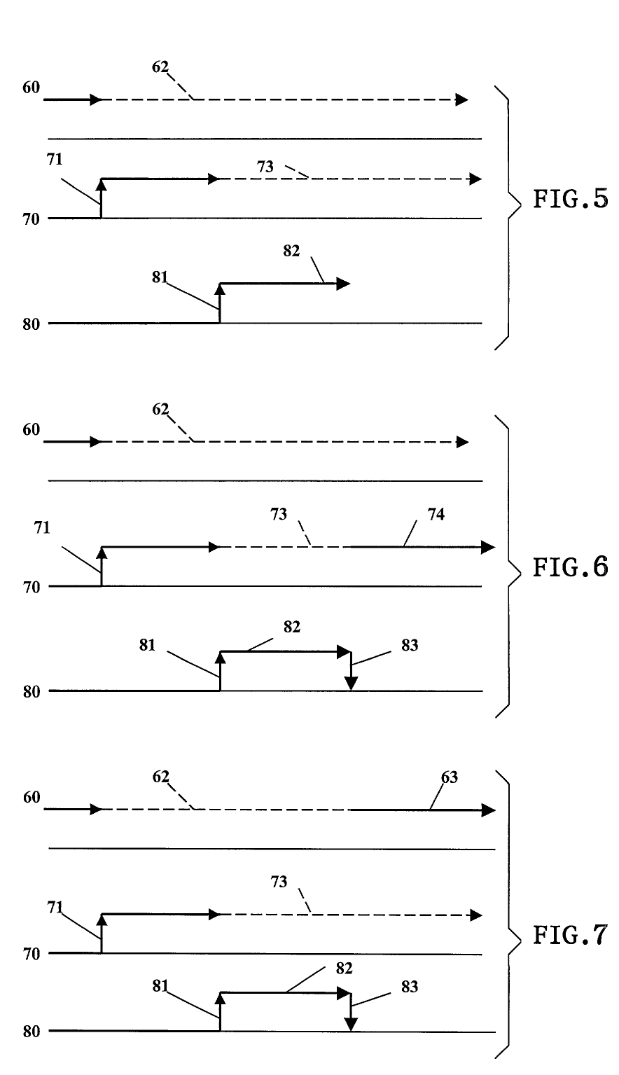

FIG. 5 illustrates that after automatic judging of each LIFO audio/video signal (60, 70 or 80), the auto-switch system will execute transmitting the latest input signal (82).

Refer to FIGS. 6 and 7, as has explained above, if current executing device that transmits output signal (82) to display device is cut off, the auto-switch system will exit current executing signal and other predefined device will continue to execute signal output to display device (FIG. 3, Block 57), the better embodiments are shown as in FIGS. 6 and 7. Once the executing signal (82) is shut down to become the low signal (83), the auto-switch system will automatically switch back to the former executing signal (belonging to signal 70) as new executing signal (73), which is illustrated in FIGS. 6. In other words, the auto-switch system will switch back in an inverted sequence to the signal that has executed output before the just interrupted one as the command of executing play and send this audio/video signal to the output module. Similarly, if this executing signal (73) is interrupted again, the auto-switch system will further switch back to previously interrupted signal (belonging to signal 60) as a command of executing play and transmit to output module.

FIG. 7 illustrates another preferred embodiment of the present invention. The auto-switch system is predefined to automatically select in correct sequence the first signal (belonging to signal 60) from the time system is activated as the executing signal (63) and transmit to output module to be the command of executing play on display device. Similarly, if this executing signal (63) is interrupted again, the auto-switch system will witch in correct sequence to the next signal (belonging to signal 70) as the command of executing play and transmit to display device.

The present invention can provide user a convenient method to activate his preferred video CD player, CD-ROM or VCR instead of witching between signal input paths with manual switch clumsily. This auto-switch system can automatically judge and select the latest input signal that is accepted by the system as the command of executing on the sound and/or image display device in great convenience and rapidness.

The present invention can be coupled to multiple signal providing devices to share a common sound and/or image display device instead of being confided to the limited number of signal sources predefined by manufactures and can automatically judge and select user's preferred signal providing device.

The LIFO choice unit for equipment of this invention can be made up of some multiplexed components such as the one with a Ser. No. F4052/34052 and relevant software program as well, or other accessible LIFO-mode stacker that have multiple-array store location configured in queue, or some other proper components that have such as similar function.

The above-mentioned embodiments give evidence of the operability of this invention in details. However, if anyone masters this technology and invents a similar system that has difference either in appearance or in details, he will be held legal responsibility of trespassing the originality and patent of this invention.

Although certain preferred embodiment of the present invention has been shown and described in detail, it should be understood that various changes and modification might be made therein without departing from the scope of the appended claims.

What is claimed is:

1. A multimedia auto-switch system comprising:
an input interface module that has multiple input interface module ports to which multiple signal providing devices can be coupled;
an output module that is coupled to at least one sound and/or image display device; and
a LIFO choice unit that can automatically judge and select the latest input signal source from said input interface module as the command of executing play and transmit the signal to said output module to be displayed on said sound and/or image display device.

2. A multimedia auto-switch system as claimed in claim 1, further comprises an memory unit that can automatically access in sequence each signal source that has been selected as the command of executing a certain operation and that can automatically switch back to a certain predefined signal providing device as the new signal source of executing play and transmit its signal to said output module when the executing signal is interrupted.

3. A multimedia auto-switch system as claimed in claim 2, wherein said memory unit's automatic switching to select a new signal source when current executing signal is interrupted refers to its switching to the signal from the signal providing devices that have been accessed from the time system is activated in correct sequence to be transmitted to said output module.

4. A multimedia auto-switch system as claimed in claim 2, wherein said memory unit's automatic switching to select a new signal source when current executing signal is interrupted refers to its switching to the signal from the signal providing device anterior to the interrupted one to be transmitted to said output module.

5. A multimedia sound and/or image display device comprising:
a device for displaying sound and/or image;
an input interface module that has multiple input interface module ports to which multiple signal providing devices can be coupled; and
a LIFO choice unit that is coupled to said sound and/or image display device at one port and to said input interface module at the other port and that can automatically judge and select the latest input signal source from said input interface module as the command of executing play and transmit the signal to said sound and/or image display device.

6. A multimedia auto-switch system as claimed in claim 5, further comprises a memory that can automatically access in sequence each signal source that has been selected as the command of executing a certain operation and that can automatically switch back to a certain predefined signal providing device as the new signal source of executing play and transmit its signal to said output module when the executing signal is interrupted.

7. A multimedia auto-switch system as claimed in claim 6, wherein said memory unit's automatic switching to select a new signal source when current executing signal is interrupted refers to its switching to the signal from the signal providing devices that have been accessed from the time system is activated in correct sequence to be transmitted to said output module.

8. A multimedia auto-switch system as claimed in claim 6, wherein said memory unit's automatic switching to select a new signal source when current executing signal is interrupted refers to its switching to the signal from the signal providing device anterior to the interrupted one to be transmitted to said output module.

9. A LIFO choice and assembly memory unit for multimedia auto-switch system, comprise a LIFO choice unit that is coupled to a sound and/or image display device at one port and at the other port, to an input interface module that has multiple input interface module ports and that can automatically judge and select the latest input signal source from said input interface module and transmit the signal to said sound and/or image display device.

10. A LIFO choice and assembly Memory unit as claimed in claim 9, is made up of built-in microcomputer in a multimedia auto-switch system.

11. A method of multimedia auto-switching comprising:
continuous input of at least one audio/video signal;
executing LIFO choice switching;
continual detection of new input signal to be transmitted to the sound and/or image display device;
if any new audio/video signal is detected to have been input, this new signal will automatically replace current executing signal immediately to be the new executing signal; and
the former executing signal will change into an ineffective phantom signal immediately.

12. A method of multimedia auto-switch as claimed in claim 11, further comprises memorizing the source of each input audio/video signal and editing the address.
